(19) United States
(12) Patent Application Publication
(10) Pub. No.: US 2016/0072577 A1
(43) Pub. Date: Mar. 10, 2016

(54) SYSTEM FOR SUPERVISING A MONOFIBRE LINE BY POLARISING A PROBE SIGNAL

(71) Applicant: ORANGE, Paris (FR)

(72) Inventors: Bertrand Le Guyader, Pommerit Jaudy (FR); Laurent Guillo, Rospez (FR); Benoit Charbonnier, Lannion (FR); Philippe Chanclou, Lannion (FR)

(21) Appl. No.: 14/782,786

(22) PCT Filed: Apr. 11, 2014
(86) PCT No.: PCT/FR2014/050886

§ 371 Date: Oct. 6, 2015

(30) Foreign Application Priority Data
Apr. 12, 2013 (FR) 1353358

(51) Int. Cl. H04B 10/077

(52) U.S. Cl. CPC H04B 10/0773; H04B 10/0775

(57) ABSTRACT

The invention relates to a method for retransmitting a probe signal, implemented by a device in a remote terminal (RT) connected to a central terminal (CT) by a monofibre optical line (MFOL), the probe signal being received by the remote terminal (RT) and having a predetermined wavelength (λprobe), the central and remote terminals exchanging over said optical lines useful data signals (λd, λu) having wavelengths other than those of the probe signal, including the following steps: receiving the polarised probe signal at a first polarity (P1); retransmitting the probe signal over the monofibre line toward the central terminal; and, prior to the retransmission step, a step of switching the first polarity (P1) of the probe signal to a second polarity (P2).

### 1. FIELD OF THE INVENTION

This patent application relates to the field of supervision of mono-fiber, point-to-point optical lines.

### 2. PRIOR ART

For an optical link between a central site and a remote site, there exist mono-fiber line supervision solutions based on the use of what is called a probe wavelength, emitted by a piece of equipment located at the central site, then returned by a piece of equipment located at the remote site. The optical link consists of a single fiber, both for the downlink, from the central site to the remote site, and for the uplink, from the remote site to the central site.

FIG. 1 shows a mono-fiber optical link MFOL between a central site CS and a remote site RS, according to the prior art. As close as possible to the remote site, or in the remote site, an optical filter Fr1 splits the probe wavelength λprobe and the wavelength λd of the downlink useful signal output from the fiber. Next, an optical fiber Fr2 combines λprobe with the wavelength λu of the uplink useful signal, and the two wavelengths λprobe and λu are reinjected into the fiber. The terminal located at the central site is able to determine with which optical power it emitted the probe signal into the MFOL fiber in the downlink direction, using a measurement point (not illustrated) located level with the laser diode LD for example. It measures the optical power of the probe wavelength λprobe coming from the fiber MFOL in the uplink direction, for example using a photodiode PD. On the basis of the difference between these two power levels, it is possible to deduce information on the operational state of the line MFOL. For example, it is thus possible to detect deterioration or breakage of the fiber, at least in theory.

One problem with this solution is due to the natural backscattering of a light signal in the optical fiber. The propagation of light in the fiber gives rise to certain effects such as Rayleigh scattering and Brillouin scattering. The first effect (Rayleigh scattering) is related to the value of the wavelength relative to the size of the constituent particles of the fiber, thus causing scattering even at low injected signal power levels. The second effect (Brillouin scattering) is a non-linear effect that appears in the fiber when the power level of the signal injected therein is too high. The consequence of these effects is that the equipment located at the central site, when it measures the optical power of the probe coming from the fiber in the uplink direction, is not able to distinguish the portion of the signal corresponding to the uplink probe signal actually re-emitted by the remote site, from the portion of the signal corresponding to the backscattering effects illustrated by “+λprobe” in FIG. 1, since these two portions are of the same wavelength. Even if the fiber has been subject to deterioration, or even completely broken, the latter portion will still remain, which will be received and measured at the central site. Such a supervision solution is therefore not very reliable.

One of the aims of the invention is to remedy these drawbacks of the prior art.

### 3. SUMMARY OF THE INVENTION

The invention improves the situation using a method for re-emitting a probe signal, implemented by a remote terminal connected to a central terminal by a mono-fiber optical line, the probe signal being received by the remote terminal and of preset wavelength, the central and remote terminals exchanging on said optical line useful data signals of wavelengths different from that of the probe signal, comprising the following steps:
receiving the probe signal; and
re-emitting the probe signal on the mono-fiber line toward the central terminal; and, the received probe signal being polarized with a first polarization, said method comprising, prior to the re-emitting step, a step of:
modifying the first polarization of the probe signal to a second polarization.

With the invention, the influence of the probe light backscattered toward the central terminal by Rayleigh scattering is limited because of the modification of the polarization of the probe by the remote terminal. Specifically, the light of probe wavelength that is backscattered before its arrival at the remote terminal possesses a polarization of the same nature as that of the light of probe wavelength itself before modification, whereas the light of probe wavelength re-emitted by the remote terminal benefits from a different polarization.

Thus, the probe wavelength traveling in the uplink direction, i.e. toward the central terminal, possesses two types of polarization: a first type corresponding to the light backscattered by the Rayleigh effect and generated by the probe signal received by the remote terminal, and a second type corresponding to the probe signal actually re-emitted by the remote terminal.

It is thus possible for a central terminal receiving these two types of polarization to distinguish between them, and to take into account only the second type for supervision of the line. If the line is broken, the second type will be absent, and vice versa.

According to one aspect of the invention, the re-emitting method comprises a step of reflecting the probe signal.

By virtue of the reflecting step, no active component for generating light is necessary in the remote terminal for the probe wavelength. The increase in power consumption induced by the re-emission of the probe signal by the remote terminal is therefore zero.

According to one aspect of the invention, the re-emitting and modifying steps are implemented in a Faraday rotator mirror.

A single passive component, the Faraday rotator mirror, conventionally used in the fabrication of laser cavities, is all that is required to implement the re-emitting and modifying modules of the remote terminal according to the invention. This innovative use of this component tends to decrease the development, production and operating costs of the central terminal according to the invention.

According to one aspect of the invention, the second polarization is rotated 90 degrees relative to the first polarization.

By modifying the polarization by about 90 degrees, with an imprecision of about two degrees due to the manufacturing processes of the components, an optimal level of differentiation between the probe wavelength backscattered by the Rayleigh effect and the probe wavelength reflected by the remote terminal is obtained. Detection of the reflected probe wavelength is thus facilitated for the central terminal.

The invention also relates to a method for processing a probe signal, implemented by a central terminal connected to a remote terminal by a mono-fiber optical line, the probe signal being of preset wavelength, referred to as probe wavelength, the central and remote terminals exchanging on said optical line useful data signals of wavelengths different from that of the probe signal, the method comprising the following steps:
emitting the probe signal on the mono-fiber optical line toward the remote terminal;
receiving a signal of probe wavelength; and
performing a measurement of power, carried out on the basis of the received signal of probe wavelength with a view to supervising the mono-fiber optical line;
   and, the emitted probe signal being polarized with a first polarization, said method furthermore comprising a step of:
splitting the received signal of probe wavelength into a first portion with the first polarization and a second portion with a second polarization, the measurement of power being carried out on the second portion.

With the invention and contrary to the prior art, one portion of the probe signal received by the central terminal implementing the processing method according to the invention is not polarized with the same polarization as the probe signal that this terminal originally emitted. As a result this portion also does not have the same polarization as another signal portion of same probe wavelength, also received by the central terminal, but generated on the mono-fiber optical line by the Rayleigh scattering effect from the probe signal originally emitted.

The central terminal is thus able to split the received signal of probe wavelength depending on the first and second polarizations, and to isolate the portion that actually corresponds to the probe signal.

The pollution that the Rayleigh effect creates at the probe wavelength is thus limited, or even eliminated. A supervision of the optical line may therefore be based on a measurement of a portion of the signal of probe wavelength that is not impacted by the Rayleigh backscattering effect. A malfunction or breakage on the optical line may thus be reliably detected.

According to one aspect of the invention, the splitting step is implemented in a polarization splitting component.

Such a polarization splitting component is for example a PSCC (polarization splitter/combiner cube), a passive component conventionally used in the core of transport networks. This innovative use of this component tends to decrease the development, production and operating costs of the central terminal according to the invention.

The invention also relates to a device for re-emitting a probe signal, implemented by a remote terminal connected to a central terminal by a mono-fiber optical line, the device being able to receive via said line at least one first so-called client wavelength and to emit toward the central terminal at least one second client wavelength, the client wavelengths carrying useful data, the device comprising:
a module for receiving what is called a probe signal of preset wavelength different from the first and second client wavelengths; and
a module for re-emitting the probe signal on the mono-fiber line toward the central terminal;
   and, the received probe signal being polarized with a first polarization, said device furthermore comprising a module for modifying the first polarization of the probe signal to a second polarization, able to be implemented prior to the re-emission of the probe signal.

The invention also relates to a device for processing a probe signal, implemented by a central terminal connected to a remote terminal by a mono-fiber optical line, the device being able to emit at least one first so-called client wavelength and to receive at least one second client wavelength, the client wavelengths carrying useful data, the device comprising:
a module for emitting toward the remote terminal a so-called probe signal of preset wavelength different from the first and second client wavelengths, referred to as the probe wavelength;
a module for receiving a signal of probe wavelength; and
a module for performing a measurement of power, carried out on the basis of the received signal of probe wavelength, with a view to supervising the mono-fiber optical line;
   and, the emitted probe signal being polarized with a first polarization, said device furthermore comprising a module for splitting the received signal of probe wavelength into a first portion with the first polarization and a second portion with a second polarization, the measurement of power being carried out on the second portion.

The invention also relates to a remote terminal, comprising a re-emitting device such as described above.

The invention also relates to a central terminal, comprising at least one device for processing a probe signal such as described above.

The invention also relates to a mono-fiber optical line supervising system, comprising a central terminal such as described above, at least one remote terminal such as described above, and at least one mono-fiber optical line able to connect the at least one remote terminal to the central terminal.

For example, the supervising system is applicable to mobile backhaul networks using the 3GPP LTE/EPC standard, in which a base station on a central site is connected by a point-to-point optical fiber to each of the remote antenna sites. For each of the fibers between the central site and a remote site, the central terminal according to the invention may be implemented in a piece of BBU (baseband unit) equipment on the base station site, and the remote terminal according to the invention may be implemented in a piece of RRH (remote radio head) equipment on the antenna site.

Another exemplary application of the supervising system according to the invention is that of point-to-point broadband optical links hired by companies to electronic communication network operators.

### 4. SUMMARY OF THE FIGURES

Other advantages and features of the invention will become more clearly apparent on reading the following description of one particular embodiment of the invention, given by way of simple illustrative and nonlimiting example and with reference to the appended drawings, in which:

FIG. 1 schematically shows a mono-fiber optical line supervising system according to the prior art;

FIG. 2 shows an exemplary implementation of a mono-fiber optical line supervising system according to one embodiment of the invention;

FIG. 3 shows the steps of methods for re-emitting a probe signal and for processing a probe signal, according to one aspect of the invention;

FIG. 4 shows the device for processing a probe signal according to one particular embodiment of the invention, implementing the processing method according to the invention;

FIG. 5 shows the device for re-emitting a probe signal according to one particular embodiment of the invention, implementing the re-emitting method according to the invention; and

FIG. 6 shows an exemplary implementation of a mono-fiber optical line supervising system according to an alternative embodiment of the invention.

### 5. DETAILED DESCRIPTION OF AT LEAST ONE EMBODIMENT OF THE INVENTION

In the rest of the description, an exemplary embodiment of the invention based on a mono-fiber optical line between two pieces of electronic communication network equipment, such as a piece of BBU equipment and a piece of RRH equipment, is described, but the invention also applies to other cases.

FIG. 1 was described above in relation to the description of problems with the prior art and will not be described in greater detail.

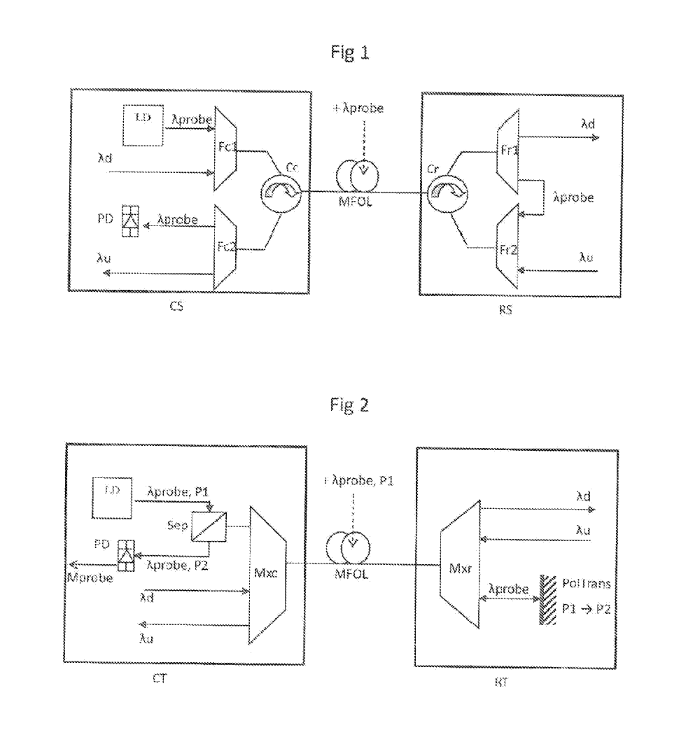

FIG. 2 shows an exemplary implementation of a mono-fiber optical line supervising system according to one embodiment of the invention.

The system comprises a central terminal CT and a remote terminal RT that are connected by a mono-fiber optical line MFOL. Downlink and uplink useful signals of respective wavelengths Ad and λu are modulated or demodulated in order to be exchanged between the two terminals, with a probe signal of wavelength λprobe, by way of their respective multiplexers/demultiplexers Mxc and Mxr.

In the terminal CT, a laser diode LD emits the probe signal of wavelength λprobe with a polarization P1. This signal may be over-modulated at a particular frequency in order to limit backscattering by the Brillouin effect. The splitting module Sep of the terminal CT makes it possible, in the downlink direction, for a signal of polarization P1 to pass without being modified, and in the other direction, for a signal of polarization P2 to be split. The photodiode PD measures the power Mprobe of the split signal, of polarization P2.

On its journey to the remote terminal RT, the probe signal of polarity P1 is subjected to Rayleigh and Brillouin backscattering effects, denoted “+λprobe,P1”, in the optical medium of the MFOL line.

In the remote terminal RT, the module PolTrans causes the probe signal to undergo a change of polarization, denoted “P1→P2”, and re-emits the signal with a polarization P2 toward the terminal CT.

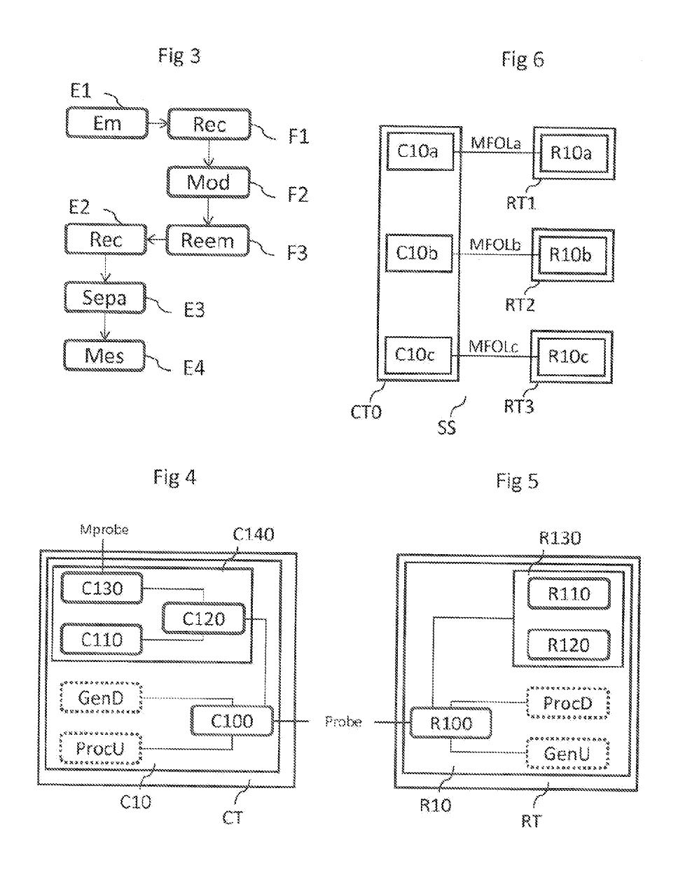

FIG. 3 shows the steps both of the method for processing a probe signal, which steps are denoted “E” followed by a number, and of the method for re-emitting a probe signal, which steps are denoted “F” followed by a number.

In a step E1 a probe signal of wavelength λprobe is emitted by a laser diode LD in the central terminal CT. By over-modulating this wavelength at a frequency of about 100 kHz, an optimal level of attenuation of the Brillouin effect is obtained. It is therefore possible to increase the power of the probe signal, and thus to increase the range of the mono-fiber optical line, without increasing the natural backscattering due to the power of the signal.

The multiplexer/demultiplexer Mxc of the central terminal CT multiplexes a plurality of signals, including the probe signal of wavelength λprobe, and at least one downlink useful signal, of wavelength λd, before emitting them on the optical line MFOL.

Like any optical signal, the probe signal of wavelength λprobe emitted by the central terminal CT toward the remote terminal RT has a certain polarization, denoted P1. The light backscattered under the action of the Rayleigh and Brillouin effects on this probe signal emitted by the terminal CT into the line MFOL will also have the same polarization P1.

When the probe signal is received, in a step F1, by the remote terminal RT, it is demultiplexed with other signals of different wavelengths, such as the downlink useful signal of wavelength λd, by the multiplexer/demultiplexer Mxr.

The probe signal is then re-emitted, in a step F3, and follows the reverse path toward the central terminal CT, by virtue of the re-emitting module PolTrans. In a step F2, this re-emitting module PolTrans also carries out an operation for modifying the polarization of the signal of wavelength λprobe. The initial polarization P1 is modified to a new value P2. The probe signal is therefore re-emitted not with a polarization P1 but P2.

The light backscattered under the action of the Rayleigh and Brillouin effects on this probe signal emitted by the terminal CT into the line MFOL will not have this polarization P2, modified by the remote terminal RT.

When the probe signal is received, in a step E2, by the central terminal CT, it is demultiplexed with other signals of different wavelengths, such as the uplink useful signal of wavelength Au, by the multiplexer/demultiplexer Mxc.

In a step E3, the probe signal is then processed by a polarization splitting module Sep, which splits the portion of the probe signal of wavelength λprobe into a first portion of polarization P1 and a second portion of polarization P2. It is known that the portion P1 is potentially polluted by the Rayleigh and Brillouin effects. This is not the case of the portion P2, since this portion has not made the “outward” trip from the central terminal CT to the remote terminal RT, but only the “return” trip, from the remote terminal RT to the central terminal CT.

In a step E4, the power of the probe signal of polarization P2 thus split and isolated is then measured by the photodiode PD.

Contrary to the prior art, the power measured is not subject to interference due to the contribution of the Rayleigh and Brillouin effects on the power of the received probe signal during the “outward” trip of the probe signal.

Another advantage of the system according to the invention is that the circulator Cc, in FIG. 1, which is indispensable in the prior art for splitting downlink wavelengths from uplink wavelengths, is no longer necessary because, to isolate the probe signal to be measured, it is enough to split the two different polarizations P1 and P2, rather than the uplink and downlink directions.

Thus, for an optical budget of 40 dB, the difference between the power of the probe signal measured at the central terminal CT in the case where the MFOL fiber is intact and the case where it is broken may reach a value of 9 to 10 dB, instead of 3 to 4 as in the prior art. In case of a deterioration of the fiber of lesser severity than a complete break, if for example a loss of 5 dB is observed, there is still a margin of detection of 4 to 5 dB above the level of the Rayleigh effect. Supervision of the mono-fiber optical line MFOL is greatly facilitated thereby.

FIG. 4 shows the device for processing a probe signal according to one particular embodiment of the invention, implementing the processing method according to the invention.

The processing device C10 comprises the following modules:
a receiving module C100, able to receive a probe signal Probe; this module may advantageously be implemented using a multiplexer/demultiplexer that is also able to demultiplex on reception a plurality of signals of different wavelengths corresponding for example to useful signals, and to multiplex on emission as many signals of the same wavelengths; the module C100 is also able to let the probe signal Probe pass in the emission direction;
an emitting module C110, able to emit a probe signal Probe; this module may advantageously be implemented using a modular laser diode;
a splitting module C120, able to split one portion of a signal with one particular polarization in one direction, and to leave unchanged the polarization of the signal in the other direction; this module may advantageously be implemented using a component of the PSCC (polarization splitter/combiner cube) type; and
a measuring module C130, able to measure the power Mprobe of an optical signal; this module may advantageously be implemented using a photodiode.

The modules C110, C120 and C130 may be grouped together in a single module C140 the function of which is to deliver a mono-fiber optical line supervision measurement Mprobe.

Advantageously, the processing device C10 may also comprise a generating module GenD, able to generate at least one downlink useful signal, and a processing module ProcU, able to process at least one uplink useful signal.

The processing device C10 may be implemented in a central terminal according to the invention, able to supervise a mono-fiber optical line using the probe signal, such as the terminal CT described with reference to FIG. 2.

FIG. 5 shows the device for re-emitting a probe signal according to one particular embodiment of the invention, implementing the re-emitting method according to the invention.

The re-emitting device R10 comprises the following modules:
a receiving module R100, able to receive a probe signal; this module may advantageously be implemented using a multiplexer/demultiplexer that is also able to demultiplex on reception a plurality of signals of different wavelengths corresponding for example to useful signals, and to multiplex on emission as many signals of the same wavelengths; the module R100 is also able to let the probe signal Probe pass in the emission direction;
a re-emitting module R110, able to re-emit a probe signal; this module R110 may advantageously be implemented using an optical mirror; and
a polarization modifying module R120, able to change an optical signal polarization P1 to a polarization P2; this module R120 may advantageously be implemented using a polarization rotator.

The modules R110 and R120 may be grouped together in a single module R130 the function of which is to re-emit a probe signal with a view to supervising a mono-fiber optical line. Advantageously, such a module R130 may for example be implemented using a Faraday rotator mirror that preferably contains a rotation of 90° of the incident polarization, i.e., in other words, giving as output a polarization P2 orthogonal to the input polarization P1. Specifically, it is easier to discriminate between two polarizations that are orthogonal to each other.

Advantageously, the re-emitting device R10 may also comprise a generating module GenU, able to generate at least one uplink useful signal, and a processing module ProcD, able to process at least one downlink useful signal.

The re-emitting device R10 may be implemented in a remote terminal according to the invention, able to re-emit on a mono-fiber optical line the probe signal, toward a central terminal able to supervise said line, such as the terminal RT described with reference to FIG. 2.

FIG. 6 shows an exemplary implementation of a mono-fiber optical line supervising system according to an alternative embodiment of the invention.

In this alternative embodiment of the invention, a plurality of mono-fiber optical lines are supervised, by virtue of the invention, by a given central terminal CT0. The central terminal CT0 comprises processing devices according to the invention C10a, C10b and C10c. The remote terminal RT1 comprises a re-emitting device according to the invention R10a. The remote terminal RT2 comprises a re-emitting device according to the invention R10b. The remote terminal RT3 comprises a re-emitting device according to the invention R10c. Thus, the system SS according to the invention allows the mono-fiber optical lines MFOLa, MFOLb, and MFOLc to be supervised by one and the same piece of equipment CT0 on the same site, thereby making hardware and power savings possible.

1. A method for re-emitting a probe signal, implemented by a remote terminal (RT) connected to a central terminal (CT) by a mono-fiber optical line (MFOL), the probe signal being received by the remote terminal and of preset wavelength (λprobe), the central and remote terminals exchanging on said optical line useful data signals of wavelengths (λd, λu) different from that of the probe signal, comprising the following steps:
(F1) receiving the probe signal; and
(F3) re-emitting the probe signal on the mono-fiber line toward the central terminal;
the method being characterized in that, the received probe signal being polarized with a first polarization (P1), said method comprises, prior to the re-emitting step, a step of:
(F2) modifying the first polarization of the probe signal to a second polarization (P2).

2. The re-emitting method as claimed in claim 1, characterized in that it comprises a step of reflecting the probe signal.

3. The re-emitting method as claimed in claim 1, characterized in that the re-emitting and modifying steps are implemented in a Faraday rotator mirror (PolTrans).

4. The re-emitting method as claimed in claim 1, characterized in that the second polarization (P2) is rotated 90 degrees relative to the first polarization (P1).

5. A method for processing a probe signal, implemented by a central terminal (CT) connected to a remote terminal (RT) by a mono-fiber optical line (MFOL), the probe signal being of preset wavelength (λprobe), referred to as probe wavelength, the central and remote terminals exchanging on said optical line useful data signals of wavelengths (λd, λu) different from that of the probe signal, the method comprising the following steps:
(E1) emitting the probe signal on the mono-fiber optical line toward the remote terminal;
(E2) receiving a signal of probe wavelength; and
(E4) performing a measurement of power (Mprobe), carried out on the basis of the received signal of probe wavelength with a view to supervising the mono-fiber optical line;
the method being characterized in that, the emitted probe signal being polarized with a first polarization (P1), it furthermore comprises a step of:
(E3) splitting the received signal of probe wavelength into a first portion with the first polarization (P1) and a second portion with a second polarization (P2), the measurement of power being carried out on the second portion.

6. The processing method as claimed in claim 5, characterized in that the splitting step is implemented in a polarization splitting component (Sep).

7. A device (R10) for re-emitting a probe signal, implemented by a remote terminal (RT) connected to a central terminal (CT) by a mono-fiber optical line (MFOL), the device (R10) being able to receive via said line at least one first so-called client wavelength and to emit toward the central terminal at least one second client wavelength, the client wavelengths carrying useful data, the device (R10) comprising:
a module (R100) for receiving what is called a probe signal (Probe) of preset wavelength different from the first and second client wavelengths; and
a module (R110) for re-emitting the probe signal (Probe) on the mono-fiber line (MFOL) toward the central terminal (CT);
characterized in that, the received probe signal (Probe) being polarized with a first polarization, said device (R10) furthermore comprises a module (R120) for modifying the first polarization of the probe signal (Probe) to a second polarization, able to be implemented prior to the re-emission of the probe signal (Probe).

8. A device (C10) for processing a probe signal, implemented by a central terminal (CT) connected to a remote terminal (RT) by a mono-fiber optical line (MFOL), the device (C10) being able to emit at least one first so-called client wavelength and to receive at least one second client wavelength, the client wavelengths carrying useful data, the device (C10) comprising:
a module (C110) for emitting toward the remote terminal (RT) a so-called probe signal (Probe) of preset wavelength different from the first and second client wavelengths, referred to as the probe wavelength;
a module (C100) for receiving a signal (Probe) of probe wavelength; and
a module (C130) for performing a measurement of power, carried out on the basis of the received signal (Probe) of probe wavelength, with a view to supervising the mono-fiber optical line (MFOL);
characterized in that, the emitted probe signal (Probe) being polarized with a first polarization, said device (C10) furthermore comprises a module (C120) for splitting the received signal (Probe) of probe wavelength into a first portion with the first polarization and a second portion with a second polarization, the measurement of power (Mprobe) being carried out on the second portion.

9-11. (canceled)

12. The re-emitting method as claimed in claim 2, characterized in that the re-emitting and modifying steps are implemented in a Faraday rotator mirror (PolTrans).

13. The re-emitting method as claimed in claim 2, characterized in that the second polarization (P2) is rotated 90 degrees relative to the first polarization (P1).

14. The re-emitting method as claimed in claim 3, characterized in that the second polarization (P2) is rotated 90 degrees relative to the first polarization (P1).
